(19) United States
(12) Patent Application Publication
(10) Pub. No.: US 2006/0118531 A1
(43) Pub. Date: Jun. 8, 2006

(54) Process for manufacturing labels and an arrangement for implementation of said process

(76) Inventor: Claes-Goran Nilsson, Boras (SE)

Correspondence Address: Orum & Roth, 53 West Jackson Boulevard, Chicago, IL, 60604-3606, US

(21) Appl. No.: 10/516,669

(22) PCT Filed: May 28, 2003
(86) PCT No.: PCT/SE03/00883

§ 371 Date: Nov. 30, 2004

(30) Foreign Application Priority Data
May 30, 2002 (SE) 0201614-5

(51) Int. Cl. B23K 26/38

(52) U.S. Cl. 219/121.72; 219/121.82; 219/121.67

(57) ABSTRACT

The present invention relates to a process for the manufacturing of labels made of textile material and for dividing them from the ribbon form (3-3ⁿ) into individual examples. In accordance with the present invention, a ribbon (3-3ⁿ) of the intended labels produced in a loom (2) is caused to be fed directly into a cutting device (4). Said ribbon of labels (3-3ⁿ) in question is caused to be clamped during the cutting operation, and preferably a laser-cutting device (5) is caused to be conveyed across said ribbon (3-3ⁿ) of labels. The cut labels (1-1ⁿ; 1A-1ⁿA . . . ) are so arranged as to be collected subsequently in a collecting position intended for this purpose. The invention also relates to an arrangement for the implementation of said process.

The present invention relates to a process for the manufacturing of labels made of textile material and for dividing them from the ribbon form into individual examples.

The production of textile labels is labour-intensive even if the labels are produced on looms where the text and logo for the appearance and form of the intended labels are transferred from computers to the loom in question. This is attributable to the fact that it is necessary to wind all the manufactured label ribbons, which leave the loom in the form of a continuous strip, into a number of smaller rolls, so that these can then be placed in previously disclosed cutting/folding machines. The cutting/folding department is at the present time the most labour-intensive department in a label manufacturing business.

Previously disclosed through U.S. Pat. No. 4,588,871 A is a process and a device for cutting a material ribbon, which runs around a roller on which a cutting device is so arranged as to operate against the roller and which is carried by a number of support arms. Cutting of said material ribbon is followed by stacking of the cut pieces.

The material ribbon moves during cutting, and a pressure roller presses the material ribbon against the roller during the period for which the latter is driven. Said process and device call for a cutter which accompanies the ribbon along its running direction, which requires special cutting arrangements and other mechanisms for the actuation and control of the cutter.

The principal object of the present invention is thus, in the first instance, to find a process which inter alia solves the above-mentioned problems and means that a number of operations can be saved so that the labels can be supplied even more rapidly than is currently the case.

Said object is achieved by means of a process in accordance with the present invention, which is characterized essentially in that a ribbon of the intended labels produced in a loom is caused to be fed directly into a cutting device, in that the ribbon of labels in question is caused to be clamped during the cutting phase, in that a cutting device is caused to be driven across said ribbon of labels, after which the cut labels are so arranged as to be collected in a collecting position for this purpose. In connection with this, a laser cutting deice can be caused to cut the labels.

Cutting devices other than laser cutting devices can be used. For example, hot melting wires and ultrasonic or hot air beam systems can be used.

Laser cutting devices, such as a CO2 laser cutter and/or a laser beam stationary generated and guided to the cutting head by mirror deflection, can be used.

The present invention also relates to an arrangement for the implementation of a process for the manufacture of labels made of textile material and the dividing of these from the ribbon form into individual examples in a labour-saving and time-saving fashion.

Said additional object is achieved by means of an arrangement in accordance with the invention, which is characterized essentially in that said cutting device is connected to the loom via a connector, and in that impulses are so arranged as to be transmitted via said connector from the loom to the cutting device when the specified length is reached and cutting is to take place.

The invention is describe below as a preferred illustrative embodiment, in conjunction with which reference is made to the accompanying drawings, in which:

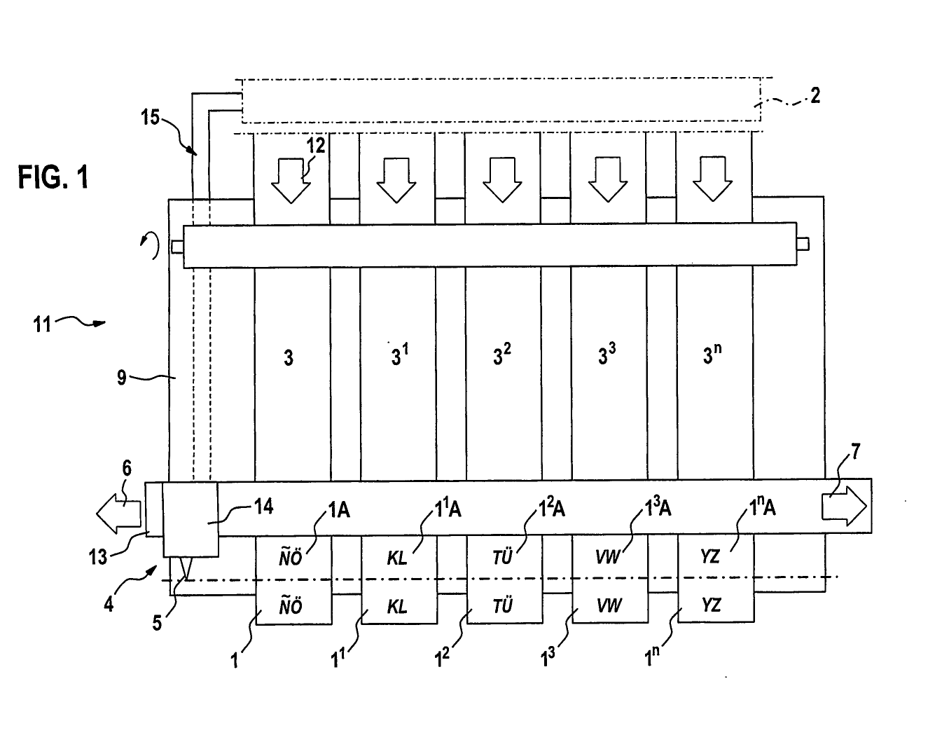

FIG. 1 shows a schematic view from above of an arrangement in accordance with the invention;

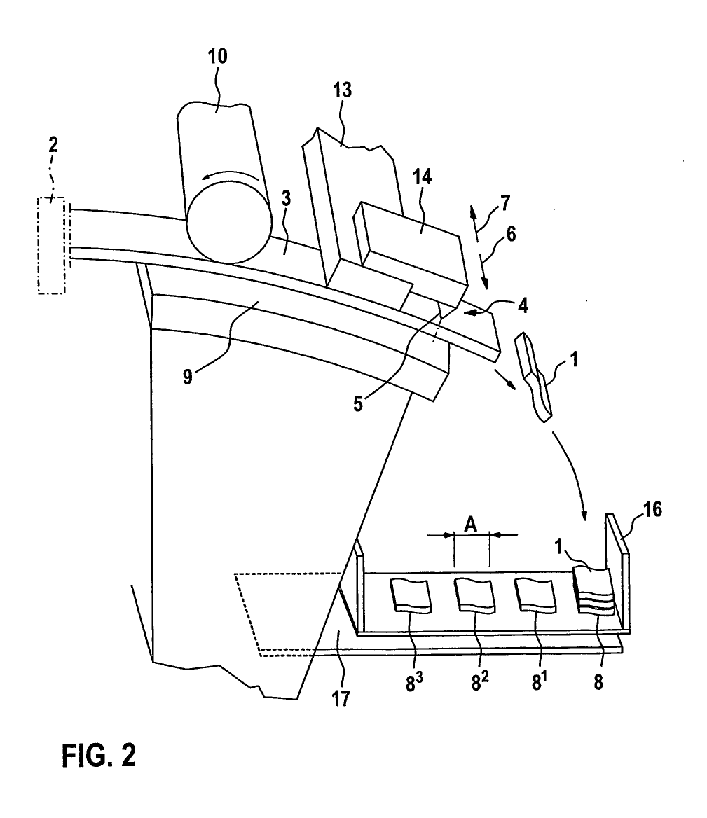

FIG. 2 shows a schematic view from the side of an arrangement in the active position;

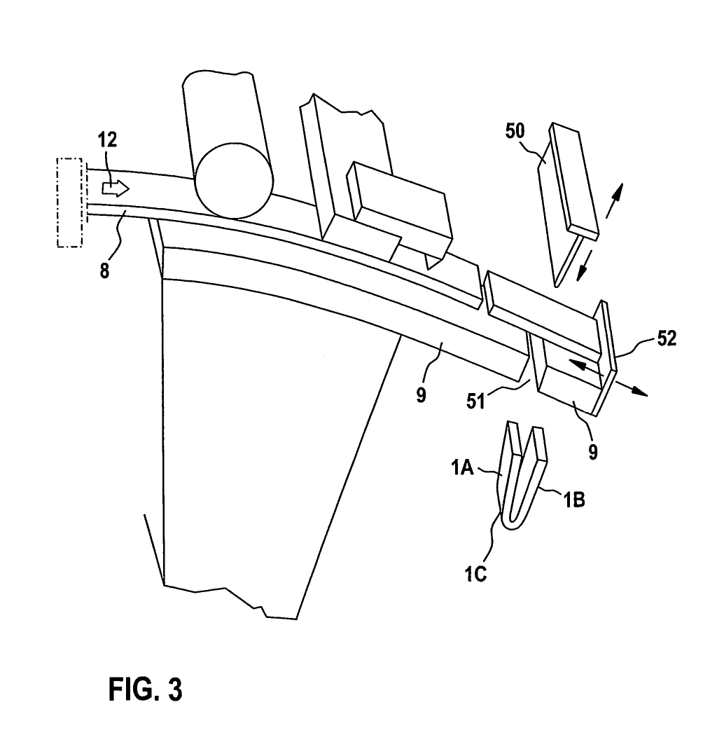

FIG. 3 shows a schematic view from the side during the folding of cut labels.

A process for the manufacture of labels 1-lⁿ which, at least for the most part, consist of textile material and are produced on a loom 2 in a previously disclosed fashion and are then arranged for the subsequent division of the same from continuous ribbon form 3-3ⁿ into individual separate examples, takes place in the following fashion in accordance with the present invention:

A ribbon 3-3ⁿ produced in a loom 2, which ribbon comprises a number of labels 1, 1A, 1¹, 1¹A, 1², 1²A, 1³, 1³A, 1ⁿ, 1ⁿA . . . situated in a line one after the other and linked together, is caused to be fed directly into a cutting device 4.

The ribbon 3-3ⁿ of labels in question is caused to be clamped during the cutting phase.

A laser cutting device 5 or some other cutting device is caused to be driven across 6, 7 said ribbon 3-3ⁿ of labels.

The cut labels 1-1ⁿ; 1A-1ⁿA . . . are then so arranged as to be collected in a collecting position for this purpose, for example in stacks 8, 8¹, 8², 8³.

As can be appreciated from FIG. 2, the ribbon 3-3n of labels arriving from the loom 2 is caused to be conveyed so that it is carried by a subjacent support table 9.

Several ribbons 3-3n of labels positioned side by side are preferably caused to be conveyed forward simultaneously, and these are then caused to be cut together in a common operation by means of the common laser-cutting device 5.

Clamping of the label ribbon/ribbons 3-3ⁿ in question is appropriately effected by means of a roller 10, which is capable of being rotated, driven and braked, a wheel or some other similar rolling arrangement.

An arrangement 11 intended for use in the implementation of a process for the manufacture of labels 1-1ⁿ in accordance with the process indicated above involves conveying a ribbon 3-3ⁿ of labels 1-1ⁿ manufactured in a line one after the other in the loom 2 directly to a cutting device 4, in which said ribbon 3-3ⁿ of labels is cut into separate labels 1-1ⁿ. Also present is a clamping device 10, which is so arranged as to clamp the ribbon 3-3ⁿ of labels temporarily during the cutting phase across 6, 7 its normal running direction 12. A laser-cutting device 5 or some other suitable cutting device, which is so arranged as to produce a soft and rounded cut edge on the labels at the time of their cutting, so that these do not feel uncomfortable against the users' bodies, is also included in the device 11. Said laser cutting device 5 is so arranged as to be conveyed across 6, 7 the running direction 12 of a ribbon 3-3ⁿ of labels of the kind in question, in such a way as to bring about cutting of said ribbon 3-3ⁿ of labels into separate individual labels 1-1ⁿ; 1A-1ⁿA . . . . In order to provide effective support for said ribbons 3-3ⁿ of labels, a table 9 or some other similar support extending in a direction from the loom 2 to the cutting device 4 is so arranged as to be capable of supporting the intended number of ribbons 3-3ⁿ of labels side by side. A driving arrangement is also so arranged as to cause said ribbons 3-3ⁿ of labels to be conveyed forward to the cutting device 4.

Said driving arrangement need not consist of yet another apparatus arranged in conjunction with said device 11, but can be formed by said locking device 10, which in turn can be formed by a roller, a wheel or some other similar rolling device, rotatably mounted in the intended driving direction 12 and capable of being driven, but above all of being braked, which is so arranged as to be capable of being brought into close contact with a ribbon 3-3ⁿ of labels in order to be able to press it against a subjacent table 9 or some other support, so that the ribbon 3-3ⁿ is arrested for as long as braking continues for the purpose of ensuring that cutting of all the ribbons 3-3ⁿ of labels in question by means of the laser cutting device 5 on one and the same occasion is achieved along the running direction of said laser cutting device across the ribbons 3-3ⁿ of labels in question when said cutting device 5 is conveyed and guided along the associated transverse runway rail 13 either by sliding or on wheels or rollers, etc. A continuous transverse clamping device 10 is thus so arranged as to be capable of making simultaneous contact with several ribbons 3-3ⁿ of labels situated side by side for the purpose of braking and conveying these on separate occasions.

The laser cutting device 5 is constituted by a guiding runway rail 13 extending across 6, 7 the label ribbon/ribbons 3-3ⁿ in question, and a laser-cutting knife 5, for example supported on a carriage 14 or some other supporting device guided by the same that is so arranged as to be conveyed forward and back 6, 7 along said guiding runway rail 13 by means of a driving arrangement in said transverse carriage 14.

Finally, it may be stated in respect of the cutting device that said laser cutting device 5 is connected to the loom 2 via a connection 15 for the transmission of data, and that impulses for this purpose are so arranged as to be transmitted via said connection 15 from the loom 2 to the laser cutting device 5 when the correct intended specified length A is reached and cutting of the ribbon 3-3ⁿ of labels to form separate individual labels 1-1ⁿ is intended to take place.

Illustrated in FIG. 3 is a means included in the arrangement 11 for causing the double folding of cut labels 1 precisely in conjunction with the cutting of same. Each label 1 is thus double-folded 1A, 1B in a common operation for all cut labels 1-1ⁿ situated across the width by causing a straight-edge 50 extending across the running direction 12 of the ribbons to be lowered, which straight-edge is capable of being caused to move in a direction across the running direction 12 of the ribbons so that each of the cut labels 1 is pushed down into a gap 51 formed in a subjacent support table 9, i.e. a table or other base upon which the labels 8-8ⁿ rest and against which they slide during transport and cutting.

In conjunction with this, it is also possible to arrange the subjacent support table so that it is actuated by heating elements, in a fashion not shown here, in order to facilitate folding of said separate cut labels 1, which are double-folded 1A, 1B about their respective central part 1C, which thus forms a hinge. The end of each of the cut labels 1 is pushed against a stop 52 before the folding operation, which means that the label is advanced to the correct position before folding.

Although not shown in the Figures, the loom could produce special controlling or cutting marks in ribbon, for instance coloured lines which are significant for the place at which the cutting device should operate. The cutting apparatus could comprise a scanning device for scanning said controlling or cutting marks and initiate a cutting operation each time the scanning device detects such a controlling or cutting mark. An arrangement for making said controlling or cutting marks in the ribbons and for scanning said marks is also a part of the invention. Such a scanning means for scanning, controlling and/or cutting marks produced in the ribbon during weaving are connected to said cutting device for initiating the cutting operation in accordance with the indicated controlling or cutting marks.

The nature and function of the invention should have been appreciated from the foregoing.

Briefly, it can be stated that the woven ribbons 3-3ⁿ, which in this case arrive directly from the loom 2, are taken up on a “cutter table” 9 where a clamping shaft 10 secures the ribbon. As the next stage, a laser knife 5 passes across the table 9 and cuts the labels, which in the following stage slide down into label boxes 16, which are standing on a collecting shelf 17.

The cutter 4 is controlled by impulses from the loom 2, which generates a signal when the specified length is reached and cutting is to take place.

The invention is naturally not restricted to the embodiment described above and illustrated in the accompanying drawings. Modifications are possible, in particular in respect of the nature of the different components, or by the use of equivalent technology, without departing from the area of protection for the invention as defined in the Patent Claims.

1. Process for the manufacturing (1-1ⁿ) of textile material and for dividing them from the ribbon form (3-3ⁿ) into individual examples, characterized in that a label ribbon (3-3ⁿ) produced on a loom (2) is conveyed directly to a cutting unit (4), in that the label ribbon in question is clamped during the cutting phase, and in that a cutting device (5) is conveyed across (6,7) said label ribbon (3-3ⁿ), after which the labels (1-1ⁿ, 1A-1ⁿA) that have been cut are so arranged as to be received in a collecting position for this purpose.

2. Process in accordance with Patent claim 1, characterized in that the label ribbon (3-3ⁿ) arriving from the loom (2) is conveyed to a subjacent support table (9).

3. Process in accordance claim 1, characterized in that several label ribbons (3-3ⁿ) positioned side by side are conveyed forward, and in that they are cut together in a common operation by means of the cutting device (5).

4. Process in accordance with Patent claim 3, characterized in that the cutting device (5) is a laser-cutting device which is preferably a CO2 laser cutter, and/or in that the laser beam is stationary generated and guided to the cutting head by mirror deflection.

5. Process in accordance with claim 1, characterized in that the label ribbon/ribbons (3-3ⁿ) in question are clamped by means of a roller (10), a wheel or a similar rolling instrument that can be rotated and braked.

6. Process in accordance with claim 1, characterized in that special controlling or cutting marks can be produced in the loom on said ribbon, for instance colored lines which are significant for the place at which the cutting device should operate, and in that the cutting apparatus, which can comprise a scanning device for scanning said controlling or cutting marks, starts to initiate a cutting operation each time the scanning device detects a controlling or cutting mark.

7. Process in accordance with claim 1, characterized in that, in conjunction with cutting of the ribbon (3), the label (1) is caused to be double-folded (1S, 1B) in a common operation for all cit labels (1-1ⁿ) situated across the width.

8. Process in accordance with Patent claim 7, characterized in that a straight-edge extending across the running direction (12) of the ribbons (8-8ⁿ) is caused to be lowered into a gap formed in the support table (9).

9. Arrangement for the implementation of a process for manufacturing labels (1-1ⁿ) of textile material and for dividing them form ribbon form into individual examples in accordance with claim 1, characterized in that a ribbon (3-3ⁿ) for the labels (1-1ⁿ) manufactured in the loom (2) leads directly to a cutting device (4), in which said label ribbon (3-3ⁿ) is cut into individual labels (1-1ⁿ), in that there is a clamping instrument (10) to clamp the label ribbon (3-3ⁿ) during the cutting phase across (6,7) its normal running direction (12), and in that a cutting device (5) is so arranged as to be conveyed across (6,7) the running direction (12) of a label ribbon (3-3ⁿ) in question for cutting said label ribbon (3-3ⁿ) into individual (1-1ⁿ, 1A-1ⁿA).

10. Arrangement in accordance with Patent claim 8, characterized in that a table (9) or some similar support, extending from the loom (2) to the cutting unit (4), is so arranged as to carry the intended number of label ribbons (3-3ⁿ) side by side, and in that a driving mechanism is so arranged as to convey said label ribbons (3-3ⁿ) to the cutting unit (4).

11. Arrangement in accordance with claim 9, characterized in that the clamping instrument (10) consists of a roller, wheel or some similar instrument, which can be rotated, driven and braked and is so arranged as to be in close contact with the label ribbon (3-3ⁿ).

12. Arrangement in accordance with Patent claim 10, characterized in that a continuous transverse clamping instrument (10) is so arranged as to bear simultaneously against several label ribbons positioned side by side.

13. Arrangement in accordance with claim 9, characterized in that the cutting device (5) is constituted by a guiding runway rail (13) extending across the label ribbon/ribbons in question, and a laser-cutting knife guided by the same (5) that is so arranged as to be conveyed forward and back (6,7) along said guiding runway rail.

14. Arrangement in accordance with claim 9, characterized in that the cutting device (5) is a laser-cutting device.

15. Arrangement in accordance with Patent claim 14, characterized in that the laser-cutting device is a CO2 laser cutter.

16. Arrangement in accordance with claim 14, characterized in that the laser beam is stationary generated and guided to the cutting head by mirror deflection.

17. Arrangement in accordance with claim 9, characterized in that the loom includes means for making special controlling or cutting marks on the ribbon during the weaving process at the place at which the cutting device shall operate.

18. Arrangement in accordance with Patent claim 17, characterized in that the cutting apparatus comprises a scanner for scanning said controlling of cutting marks.

19. Arrangement in accordance with Patent claim 18, characterized in that the cutting apparatus comprises starting means to initiate a cutting operation each time the scanning device detects a controlling or cutting mark.

20. Arrangement in accordance with claim 9, characterized in that said cutting device (4) is connected to the loom (2) via a connector (15), and in that impulses are sent via said connector (15) from the loom (2) to the laser cutting device (4) when the specified length is reached and cutting is to take place.

21. Arrangement in accordance with claim 9, characterized in that the cutting device (4) is connected to the weaving loom (2) by means of a plug (15), and in that data in respect of the cutting intensity and synchronization of the cutting speed between the weaving machine control and the cutting device control is exchanged via this plug connection (15).

22. Arrangement in accordance with claim 9, characterized in that the cut labels are systematically arranged in a packaging unit immediately following the cutting procedure.

23. Arrangement in accordance with claim 9, characterized in that a straight-edge (5) extending across the support table (9) is capable of being caused to move down into matching gaps (51) extending across the running direction (12) of the label ribbons (3) for the purpose of the double-folding (1A, 1B) of cut labels (1-1ⁿ) and pushing them through the gap (51).

24. Arrangement in accordance with Patent claim 23, characterized in that the gap (51) extends all the way across the support table (9).
